(19) United States
(12) Patent Application Publication
(10) Pub. No.: US 2007/0145636 A1
(43) Pub. Date: Jun. 28, 2007

(54) Ink tank incorporating lens for ink level sensing

(76) Inventors: Gina Marie Johns, Nicholasville, KY (US); Ganesh Vinayak Phatak, Lexington, KY (US); Jeffrey Louis Sangalli, Louisville, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/320,364

(22) Filed: Dec. 28, 2005

(51) Int. Cl. B29C 45/14; B29D 11/00; B65D 25/54

(52) U.S. Cl. 264/259; 264/2.7; 220/663

(57) ABSTRACT

A tank for a micro-fluid ejection device and a method for making the tank containing a liquid level lens. The tank includes a tank body made of a first material defining a lens aperture. A lens made of a second material that is different from the first material is disposed within the lens aperture.

### FIELD 10011 The disclosure relates to fluid supply tanks for micro-fluid ejection heads, and in particular, to methods for fabricating fluid supply tanks for micro-fluid ejection heads.

### BACKGROUND AND SUMMARY

Micro-fluid ejection heads, such as inkjet print cartridges, may include a disposable ink supply tank for supplying ink to permanent or semi-permanent printheads. Such tanks may include a transparent lens in the tank that is used to reflect light to a sensor for optically sensing the presence or absence of ink in the tank. When an absence of ink is detected, a command signal is generated to limit operation of the printhead so that damage to the printhead is avoided. Fabrication of tanks having suitable lenses is challenging and improvement is needed.

Accordingly, the disclosure relates to a tank for a micro-fluid ejection device and methods for making the tank containing a liquid level lens. In some embodiments, the tank includes a tank body made of a first material defining a lens aperture, and a lens made of a second material that is different from the first material is disposed within the lens aperture.

In other embodiments, there is provided a method for making a tank containing a fluid level lens therein. The method includes providing a lens made of a lens material having a first melting point. The lens is placed within a mold configured to provide a tank body having a lens aperture therein. A tank material is introduced into the mold containing the lens to yield a tank having the lens bonded within the lens aperture of the tank body. The tank material used for making the tank body has a second melting point less than the first melting point of the lens material.

An advantage of exemplary embodiments described herein is the provision of a tank/lens assembly having improved lens and tank properties as compared to conventional structures.

Further advantages of the exemplary embodiments will become apparent by reference to the detailed description when considered in conjunction with the figures, which are not to scale, wherein like reference numbers indicate like elements through the several views, and wherein:

### BRIEF DESCRIPTION OF THE DRAWINGS

FIG. 1 is a sectional perspective view of a tank/lens assembly of a micro-fluid ejection head according to the disclosure.

FIG. 2 is a perspective view of a lens component of the ejection head of FIG. 1.

FIG. 3 is a sectional perspective view of a tank component of the ejection head of FIG. 1.

FIG. 4 is a cross-sectional side view of a tank/lens assembly showing its relationship to a printhead and an optical sensor of a micro-fluid ejection device.

FIG. 5 is a top perspective view of a tank/lens assembly according to the disclosure.

FIG. 6 is a bottom perspective view of a tank/lens assembly according to the disclosure.

FIG. 7 is a perspective view of a plurality of tank/lens assemblies according to the disclosure installed in a carriage for supplying fluid to a plurality of micro-fluid ejection heads of a micro-fluid ejection device.

### DETAILED DESCRIPTION OF EXEMPLARY EMBODIMENTS

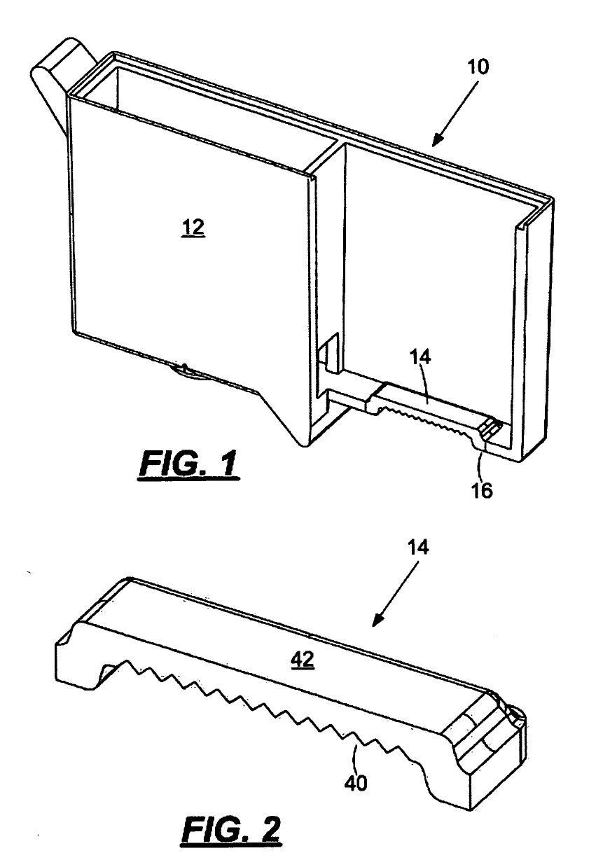

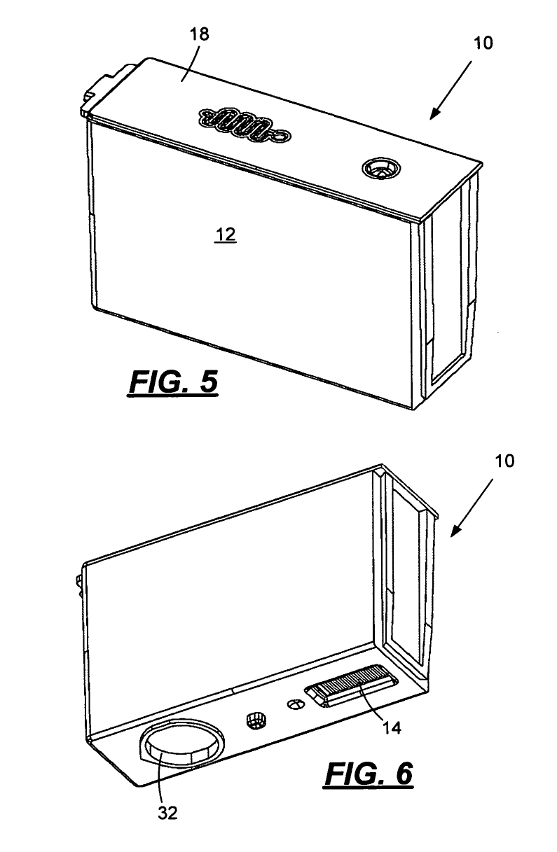

With reference to FIGS. 1-6, there is shown a tank/lens assembly 10, according to the disclosure for providing fluid to a micro-fluid ejection device. The tank/lens assembly 10 includes a tank body 12 and a lens 14 mounted within a lens aperture 16 of the tank body. A lid 18 (FIG. 5) is installed on the tank body 12 so that the tank body 12 may be filled with a fluid, such as ink.

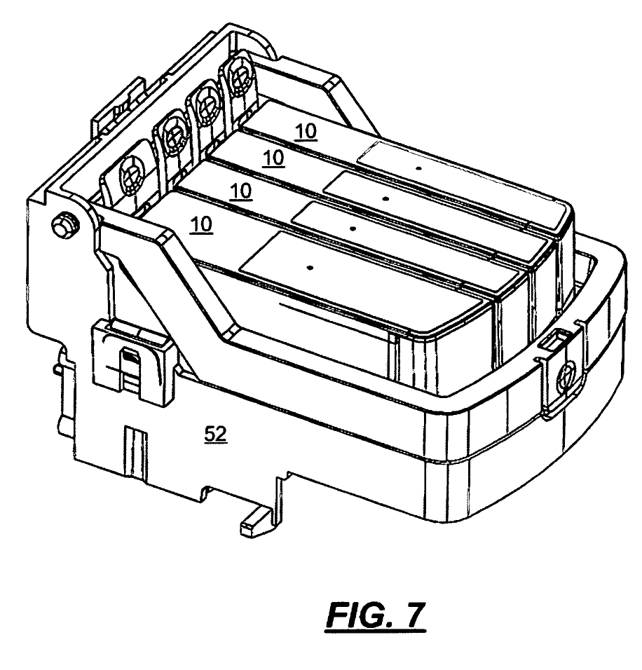

The tank/lens assembly 10 is particularly suitable for use as a disposable fluid supply to supply fluid, such as ink, to a micro-fluid ejection device, such as a permanent or a semi-permanent printhead utilized by an inkjet printer, as described in more detail below in connection with FIG. 7.

The assembly 10 is made by providing the lens 14 and the tank body 12 in separate forming steps. The tank 12 and the lens 14 being made of different but chemically compatible materials, with the pre-formed lens 14 being integrated into the tank body 12. The lens 14 may be integrated into the tank body 12 during formation of the tank body 12 or after formation of the tank body 12. Separate formation of the lens 14 enables both the tank body 12 and the lens 14 to each be made of a material suitable for their purpose. Conventional constructions provide a tank body and a lens in a single molding step, with the tank body and the lens being simultaneously formed of the same material that is a compromise to the desired performance of at least the lens. That is, materials that facilitate the molding of the tank body typically have disadvantages for use as lens materials, such as low scratch resistance or a high shrinkage rate, poor transparency, and the like which compromises the formation of the desired lens shape for fluid level sensing or detection applications. Likewise, materials suitable for forming the transparent lens may be more costly to use for the entire tank material and may have poorer compatibility with the fluid contained in the tank body.

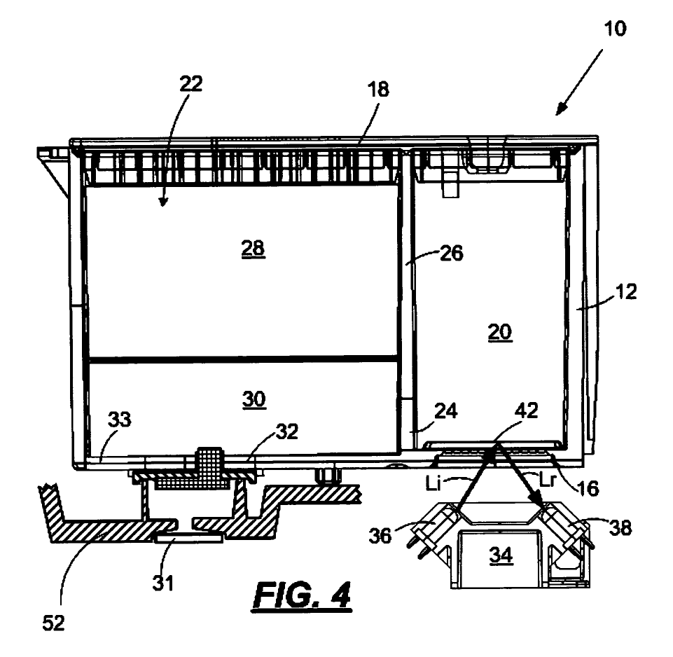

With continuing reference to FIG. 3, and with additional reference to FIG. 4, the tank body 12 is desirably of one-piece molded plastic construction, and made of a first material that is selected to be economical and have a high chemical resistance to the fluid to be contained by the tank body 12. Suitable materials which may be used in manufacture of the tank body 12 for holding fluids such as inks of the type commonly used in inkjet printing include polypropylene and high density polyethylene (HDPE). Other suitable materials may include a polymeric material selected from the group consisting of amorphous thermoplastic polyetherimide available from G.E. Plastics of Huntersville, N.C. under the trade name ULTEM 1010, glass filled thermoplastic polyethylene terephthalate resin available from E. I. du Pont de Nemours and Company of Wilmington, Del. under the trade name RYNITE, syndiotactic polystyrene containing glass fiber available from Dow Chemical Company of Midland, Mich. under the trade name QUESTRA, polyphenylene oxide/high impact polystyrene resin blend available from G.E. Plastics under the trade names NORYL SEI and polyamide/polyphenylene ether resin available from G.E. Plastics under the trade name NORYL GTX. Still other materials that may be used for the tank body 12 include, but are not limited to, polypropylene (PP), polymethylmethacrylate (PMMA), polycarbonate (PC), styrene-acrylonitrile (SAN), polypropylene/ethylene-propylene-diene monomer (PP/EPDM), polyvinylchloride with plasticizer (PVC-W), polybutyleneterephthalate (PBT), polysulfone (PSU), and thermoplastic polyurethane (TPU).

With reference to FIG. 4, the tank body 12 may include a pair of chambers 20 and 22 interconnected by a passage 24 formed through a lower portion of a partition 26 between the chambers 20 and 22. The chamber 20 contains a supply of fluid, such as ink. The chamber 22 may be substantially filled with permeable solid material, such as one or more porous absorbent members 28 and 30, such as felted foam blocks, for inducing a negative pressure and enabling a uniform supply of fluid to a micro-fluid ejection head 31. The fluid travels from the chamber 20 through the passage 24 and accumulates in the chamber 22 so that the fluid level is substantially equalized between the chambers 20 and 22. During operation of the micro-fluid ejection head 31, fluid flows from the chamber 22 to the ejection head 31 via a supply port 32 located in a side wall 33 of the tank body 12 adjacent to the chamber 22.

The lens aperture 16 is defined on the side wall 33, so that the lens 14 may be located in the aperture 16 adjacent to the chamber 20. As depicted in FIG. 4, a sensor 34 associated with the micro-fluid ejection device, such as a printer, is located for cooperation with the lens 14. For example, the sensor 34 may be located on a printer so as to be immediately below the chamber 20 at least periodically during printing operations.

The sensor 34 may include a source of light 36, such as a light emitting diode, positioned so as to direct light angularly toward the lens 14. If the chamber 20 contains sufficient ink to cover the lens 14, then a low to medium amount of light will be reflected for detection by a detector 38. If the chamber 20 is empty or otherwise does not contain sufficient ink to cover the lens 14, then a medium to high amount of light will be reflected back to the detector 38, as depicted in FIG. 4 by arrows Li and Lr, representing the incident light (Li) and the reflected light (Lr). The presence or absence of reflected light may be used to provide a signal to a controller to limit operation of the micro-fluid ejection device so that damage to the micro-fluid ejection head 31 is avoided.

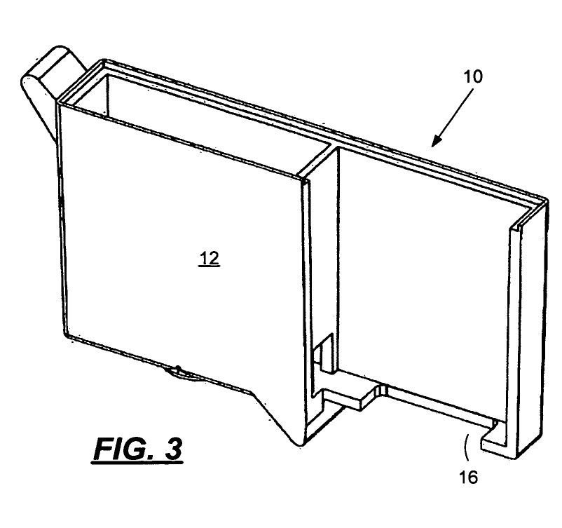

To enable the desired light reflection function, the lens 14 may include a stepped configuration as seen in FIG. 2 having a serrated surface 40 and a relatively smooth surface 42 opposite the serrated surface 40. Suitable lens geometry is described in co-pending application Ser. No. 11/206,610, filed Aug. 17, 2005, entitled “System, Methods, and Apparatuses for Sensing Ink Container and In Presence,” and incorporated herein by reference in its entirety.

It has been observed that lens structures made using materials such as clear polypropylene or HDPE have disadvantages such as poor optical properties and low scratch resistance. Accordingly, the lens 14 is suitably made using a material having desirable optical and mechanical properties. For there to be sufficient internal reflection when no fluid is present above the lens, the refiactive index may be selected so that the light incident on the lens/air interface is at an angle greater than the critical angle associated with the two mediums. To achieve this, with the given sensor configuration where light is incident on the lens surface at a 45 degree angle, the material is selected to have a refractive index greater than about 1.445. The lens material must also be chemically compatible with the tank material. Accordingly, suitable lens materials may be selected from polypropylene (PP), polymethylmethacrylate (PMMA), polycarbonate (PC), and styrene-acrylonitrile. The following Table 1 provides the melting points of the lens and tank materials that may be used. Table 2 provides a selection chart for selecting suitable lens materials for the tank materials and vice versa.

TABLE 1

| | Mean Melt | Melt |
|---|---|---|
| | Temperature | Temperature |
| Material | (° C.) | Range (° C.) |
| Polypropylene (PP) | 230 | 200-280 |
| Styrene-acrylonitrile (SAN) | 230 | 200-270 |
| Polycarbonate (PC) | 293 | 282-304 |
| Polymethylmethacrylate (PMMA) | 250 | 240-280 |
| Polypropylene/ethylene-propylene diene | 240 | 220-260 |
| monomer (PP/EPDM) | | |
| Polyvinylchloride with plasticizer | 180 | 160-200 |
| (PVC-W) | | |
| Polybutyleneterephthalate (PBT) | 260 | 250-270 |
| Thermoplastic Polyurethane (TPU) | 230 | 223-240 |
| Polysulfone (PSU) | 189 | 188-190 |

TABLE 2

| Lens | Tank | Tank | Tank | Tank | Tank | Tank |
|---|---|---|---|---|---|---|
| Material | Material | Material | Material | Material | Material | Material |
| PP | PP | PP/EPDM | — | — | — | — |
| PMMA | PMMA | PVC-W | — | — | — | — |
| PC | PC | PBT | PSU | TPU | PP/EPDM | — |
| SAN | SAN | PBT | — | PMMA | PVC-W | TPU |

As seen by table 2, materials that are compatible with a PP lens material, for example, include PP and PP/EPDM. In another example, a lens material made of SAN may be compatible with a tank material selected from SAN, PBT, PMMA, PVC-W, and TPU.

Various methods may be used to fixedly attach the lens 14 in the aperture 16 of the tank 10. In one manner of attachment, the lens 14 may be mechanically secured within the aperture 16 of the tank body 12 as by a friction fit and a suitable adhesive or the like to provide a hermetic seal at an interface between the lens 14 and the body 12 so that air does not enter chambers 20 or 22 and fluid does not escape therefrom. Other means for securing the lens 14 in the aperture 16 include, but are not limited to, ultrasonic welding, laser welding, and the like.

In another method of manufacture, the lens 14 may be provided, as by conventional injection molding techniques, and the lens subsequently incorporated into the tank body 12 during manufacture of the tank body 12. For example, the formed lens 14 may be installed in a mold configured to provide the tank body 12 depicted in FIG. 3 having the tank aperture 16. Tank material is injected into the mold containing the lens to yield the tank/lens assembly 10 having the lens 14 bonded within the lens aperture 16 of the tank body 12.

During the foregoing tank molding procedure, it is desirable that the lens material have a melting point that is sufficiently greater than the melting point of the tank material so that the lens 14 does not deform under the thermal conditions associated with molding the tank body 12 so that the lens 14 substantially retains its shape and optical properties. For example, a suitable tank material, such as PP/EPDM has a lower melting point of 220° C., and a suitable lens material for the tank material is a lens material such as polypropylene having an upper melting point 280° C.

Use of a lens 14 made of one of the foregoing lens materials in the above described integrated molding step desirably results in the formation of a chemical and mechanical bond between the lens material and the tank material that creates a hermetic seal between the tank body 12 and the lens 14, while the lens 14 substantially retains its shape and optical properties. Without being bound by theory, it is believed that during the body molding step for integrating the lens 14 in the body 12, some of the boundary regions of the lens 14 soften under frictional and thermal forces associated with the molding process to promote bonding between the lens 14 and body 12 without altering the optical properties of the relevant surfaces of the lens 14.

With reference to FIG. 7, a plurality of the tank/lens assemblies 10 are shown installed on a carrier 52 containing micro-fluid ejection heads for a micro-fluid ejection device such as a printer. The micro-fluid ejection heads may be semi-permanent or permanent ejection heads associated with an ink jet printer and the tank/lens assemblies 10 may each contain different color inks. Periodic movement of the carrier 52 in a printer carriage across the sensor 34 provides periodic indication of the status of fluid in each of the tank/lens assemblies 10.

Having described various aspects and exemplary embodiments and several advantages thereof, it will be recognized by those of ordinary skills that the disclosed embodiments is susceptible to various modifications, substitutions and revisions within the spirit and scope of the appended claims.

What is claimed is:

1. A tank for a micro-fluid ejection device, the tank comprising:
a tank body defining a lens aperture, the tank body being made of a first material; and
a lens within the lens aperture, the lens being made of a second material that is different from the first material.

2. The tank of claim 1, wherein the second material has a melting point that is greater than the melting point of the first material.

3. The tank of claim 1, wherein the first material is selected from the group consisting of polypropylene (PP), polymethylmethacrylate (PMMA), polycarbonate (PC), styrene-acrylonitrile (SAN), polypropylene/ethylene-propylene diene monomer (PP/EPDM), polyvinylchloride with plasticizer (PVC-W), polybutyleneterephthalate (PBT), polysulfone (PSU), and thermoplastic polyurethane (TPU), and the second material is selected from the group consisting of PP, PMMA, PC, and SAN.

4. The tank of claim 1, wherein the lens is hermetically sealed within the lens aperture.

5. The tank of claim 4, wherein the lens is hermetically sealed by a process selected from the group consisting of adhesive sealing, laser welding, and ultrasonic welding.

6. The tank of claim 1, wherein the lens is adhesively sealed within the lens aperture.

7. The tank of claim 1, wherein the lens is hermetically sealed within the lens aperture by placing the lens within a mold configured to provide the tank body having the lens aperture and the first material is introduced into the mold containing the lens under conditions sufficient to yield the tank having the lens bonded within the lens aperture of the tank body.

8. A method for making a tank containing a fluid level lens therein, the method comprising the steps of:
providing a lens made of a lens material having a first melting point;
placing the lens within a mold configured to provide a tank body having a lens aperture therein; and
introducing a tank material into the mold containing the lens to yield a tank having the lens bonded within the lens aperture of the tank body, the tank material having a second melting point less than the first melting point of the lens material.

9. The method of claim 8, wherein the lens material is selected from the group consisting of polypropylene (PP), polymethylmethacrylate (PMMA), polycarbonate (PC), styrene-acrylonitrile (SAN), and the tank material is selected from the group consisting of PP, PMMA, PC, and SAN, polypropylene/ethylene-propylene-diene monomer (PP/EPDM), polyvinylchloride with plasticizer (PVC-W), polybutyleneterephthalate (PBT), polysulfone (PSU), and thermoplastic polyurethane (TPU).

10. The method of claim 8, wherein the tank material has a melting point ranging from about 0° to about 120° C. lower than the melting temperature of the lens material.

11. A method for making a fluid container for a micro-fluid injection device, the method comprising the steps of:
providing a liquid level lens made of a lens material having a first melting point;
placing the lens within a mold configured to provide a tank body having a lens aperture therein; and
introducing a tank material into the mold containing the lens under conditions sufficient to yield the tank body having the lens bonded within the lens aperture of the tank body, the tank material having a second melting point less than the melting point of the lens material.

12. The method of claim 11, wherein the lens material is selected from the group consisting of polypropylene (PP), polymethylmethacrylate (PMMA), polycarbonate (PC), styrene-acrylonitrile (SAN), and the tank material is selected from the group consisting of PP, PMMA, PC, and SAN, polypropylene/ethylene-propylene-diene monomer (PP/EPDM), polyvinylchloride with plasticizer (PVC-W), polybutyleneterephthalate (PBT), polysulfone (PSU), and thermoplastic polyurethane (TPU).

13. The method of claim 11, wherein the lens is hermetically sealed within the lens aperture.
